(19) United States
(12) Patent Application Publication
(10) Pub. No.: US 2006/0181592 A1
(43) Pub. Date: Aug. 17, 2006

(54) Ink-jet recording medium

(75) Inventors: Iskandar Gandasasmita, Tilburg (NL); Andries Johannes Jozef van Es, Dorst (NL); Jan Bastiaan Bouwstra, Bilthoven (NL); Yoichiro Kamiyama, Tilburg (NL); Yuzo Toda, Goirle (NL); Antonius Josephus Bernardus Kemperman, Enschede (NL); Geert Hendrik Koops, Zwolle (NL)

Correspondence Address: BANNER & WITCOFF, LTD., 28 STATE STREET, 28th FLOOR, BOSTON, MA, 02109-9601, US

(73) Assignee: Fuji Photo Film B.V., Tilburg (NL)

(21) Appl. No.: 11/340,417

(22) Filed: Jan. 26, 2006

Related U.S. Application Data
(63) Continuation of application No. PCT/NL04/00567, filed on Aug. 12, 2004.

(30) Foreign Application Priority Data
Aug. 13, 2003 (EP) 03077532.4

(51) Int. Cl. B41J 3/407

(52) U.S. Cl. 347/106

(57) ABSTRACT

The present invention relates to a recording medium, in particular an ink-jet recording medium of photographic quality that has excellent ink absorption speed, good drying characteristics and a good image printing quality. According to the present invention, an ink-jet recording medium is provided, comprising a support and an ink-receiving layer which has an asymmetric membrane structure comprising a dense top layer adjacent to a microporous sublayer, said ink-receiving layer comprising at least one water-swellable polymer. The present invention is further directed to methods for obtaining such a medium.

### FIELD OF INVENTION

The present invention relates to a recording medium, in particular to an ink-jet recording medium of photographic quality that has excellent ink absorption speed, good drying characteristics and a good image printing quality.

### BACKGROUND OF THE INVENTION

In a typical ink-jet recording or printing system, ink droplets are ejected from a nozzle at high speed towards a recording element or medium to produce an image on the medium. The ink droplets, or recording liquid, generally comprise a recording agent, such as a dye, and a relatively large amount of solvent in order to prevent clogging of the nozzle. The solvent, or carrier liquid, typically is made up of water, and organic material such as monohydric alcohols and the like. An image recorded as liquid droplets requires a receptor on which the recording liquid dries quickly without spreading. Good absorption of ink encourages image drying while minimizing dye migration by which good sharpness of the recorded image is obtained. In general the receptor comprises a support and an ink-receiving layer. One of the important properties of the ink-receiving layer is the liquid absorption speed. The majority, if not all, of the ink solvent has to be absorbed by the layer itself. Only when paper or cloth or cellulose is used as a support, some part of the solvent may be absorbed by the support. It thus follows that when the ink-receiving layer comprises a binder and a filler they both should have a significant ability to absorb the ink solvent.

There are in general two approaches for producing ink-jet recording media with photographic quality and good drying properties.

One type of ink-jet recording media of photographic quality having reasonable drying properties is the so called “non-microporous film type”, also known as “swellable type”, as proposed in several patent publications such as EP-A-806 299 and JP-A-22 76 670. For this type of ink-jet recording medium, at least one ink receptive layer is coated on a support such as a paper or a transparent film. One way to improve the liquid absorption and drying rates of these media is the use of water swellable polymers. DE-A-223 48 23, DE-A-19721238 and U.S. Pat. No. 4,379,804 disclose methods in which gelatin is used in ink-receptive layers of ink-jet receiving sheets. From these documents, it has become clear that gelatin has an advantageous function for the absorption of ink solvents. The gelatin is said to improve smudge resistance and to increase the image definition quality.

The other general approach is the use of inorganic porous particles such as silica, alumina hydrate and pseudo-boehmite that are responsible for the porous character of the medium as described in e.g. EP-A-0 761 459 and EP-A-1 306 395. These media show good drying properties but their dye stability is not so good.

Another known approach is to provide a support with a microporous film, which can act as the ink receptive layer. However, this known technique may give problems as to the gloss of the media and may result in a low optical density of the printed images.

U.S. Pat. No. 4,833,172 describes a method to produce a microporous film by stretching a sheet that comprises polyolefin, water insoluble siliceous particles and specific processing plasticisers, followed by removing said plasticiser after stretching. In order to increase the gloss, said microporous film may be calendered.

U.S. Pat. No. 5,605,750 proposes an ink jet medium comprising a support, a thin microporous film as produced, among others, by the method mentioned in U.S. Pat. No. 4,833,172 and an upper image-forming layer of porous pseudo-boehmite having an average pore radius of from 1 to 8 nm (10 Å to 80 Å). Said medium provides high optical density and good color gamut on the recorded images.

There are several other documents describing the use of a stretched microporous film for ink jet media such as WO-A-99/41086, U.S. Pat. No. 4,861,644, WO-A-97/33758 and WO-A-02/053391.

In the membrane technology field, microporous materials with a selectivity for particles with a certain size are produced by the so-called “phase inversion” technique. U.S. Pat. No. 6,132,858 describes the application of this phase inversion technique to produce a microporous support suitable for ink jet printing media. Herein, a water insoluble polymer is dissolved in an organic solvent, coated on a support and then subjected to a non-solvent fluid quench which causes the polymer solution to phase invert and form the solid porous coating layer on the support. In this process, water is typically used as a non-solvent fluid and the polymers are typically hydrophobic polymers. Also EP-A-1 176 030 describes the employment of the phase inversion technique using water insoluble polymers.

Several patent publications e.g. EP-A-0 156 532 and US-A-2001/0021439, disclose a single porous layer of homogeneous structure while in other applications some methods are disclosed for the design of an inkjet image recording material with two distinctive layers adjacent to each other, one with microporous characteristics and one with swellable characteristics. EP-A-1 211 089 and EP-A-1 176 029 disclose a two layer ink jet image receiving element wherein the layer adjacent to the support consists of a hydrophilic, fluid-absorbing swellable polymer and the outermost layer is an ink receptive layer comprising an open pore structure formed by dry phase inversion, wherein a mixture of a good solvent and a poor solvent is incorporated in the solution of said outermost layer and wherein the boiling point of the poor solvent is higher than that of the good solvent. The main polymer is a hydrophobic polymer and water is applied as a non-solvent.

EP-A-0 812 697 discloses a two layer ink jet receiving element wherein the microporous layer is in-between the support and the ink receptive layer.

When comparing both solutions for providing an ink-jet recording medium (viz. a medium having a microporous layer or a medium having a water swellable layer), it was found that both solutions have their positive and negative characteristics.

On the one hand, the microporous ink-jet recording media have excellent drying properties, but generally suffer from dye fading. On the other hand the swellable type of ink-jet recording media may give less dye fading, but generally dry more slowly.

The multilayer materials with both a swellable layer and a distinctive microporous layer suffer basically from the same quality problems, as an outer microporous layer results in a bad dye fading behaviour and a bad gloss, and an outer swellable layer with a microporous sublayer does not solve the drying problem.

There remains a strong need for ink-jet recording media having excellent drying properties and which show minimal dye fading. In addition, these ink-jet recording media should preferably have properties such as suitable durability, good sheet feeding property in ink-jet printers, good image density, as well as a good resolution.

It is towards fulfilling this need that the present invention is directed.

### SUMMARY OF THE INVENTION

It is an object of this invention to provide an ink-jet recording medium having excellent drying characteristics and also excellent dye fading resistance in combination with a high gloss.

It has been found that these objectives can be met by providing an ink-jet recording medium comprising at least one layer, which is both porous and swellable at the same time. This new and unique design of this so-called swellable microporous layer solves the problems existing in the art remarkably well. Thus the present invention provides an ink-jet recording medium comprising a support and a water swellable ink receiving layer adhered to said support, wherein said ink receiving layer has an asymmetric membrane structure, viz. the ink receiving layer comprises a dense toplayer adjacent to a microporous sublayer, which ink receiving layer comprises at least one water-swellable polymer. “Dense toplayer” means that the porosity of the toplayer is less than the porosity of the microporous sublayer.

The swellable microporous ink receptive layer may be characterized by that it comprises:
at least one water swellable polymer;
pores/voids, preferably having a void volume between 5 to 95 volume percent of the ink receptive layer;
a microporous sublayer the pores/voids of which preferably have an average pore diameter of between 100 nm and 10 μm, preferably between 200 nm and 5 μm; and
a thin dense top-layer (also referred to as skin-layer), which is present on the microporous sublayer, which top-layer preferably has a void volume of less than 20 volume percent of the ink receptive layer and an average pore diameter of less than 1 μm;
preferably of less than 0.1 μm.

Pore diameters and pore volume as expressed herein, are suitably assessed by measuring the dimensions of the pores from the cross section pictures made by Scanning Electron Microscopy (SEM), which pictures are taken at a proper magnification. An average diameter is obtained by measuring a number of different cross sections, typically five different cross sections.

The term “water-swellable polymer” as used herein, refers to a polymer that swells when contacted with water. In particular said polymer is able to absorb water resulting in a thickness increase of at least 3% compared to its dry thickness, more typically at least 7%, even more at least 12%.

### DESCRIPTION OF THE DRAWINGS

FIG. 1 shows a SEM picture of a cross section of the asymmetric membrane according to this invention, comprising a dense top layer (1) and a microporous sublayer (2). It was produced by an immersion precipitation method, wherein a dope solution comprising a 15% aqueous solution of lime treated gelatin was coated onto a substrate. The coated substrate was immersed into an ethanol bath (absolute grade from Merck, Germany) at 25° C. The solid content of the asymmetric membrane is 30 g per m². The dense toplayer (1) has a thickness of about 1 micrometer. Under the dense toplayer, a microporous sublayer (2) is present.

FIG. 2 is a magnification of a part of FIG. 1 showing the porous structure of the microporous sublayer (2). The highly porous structure clearly has interconnecting pores.

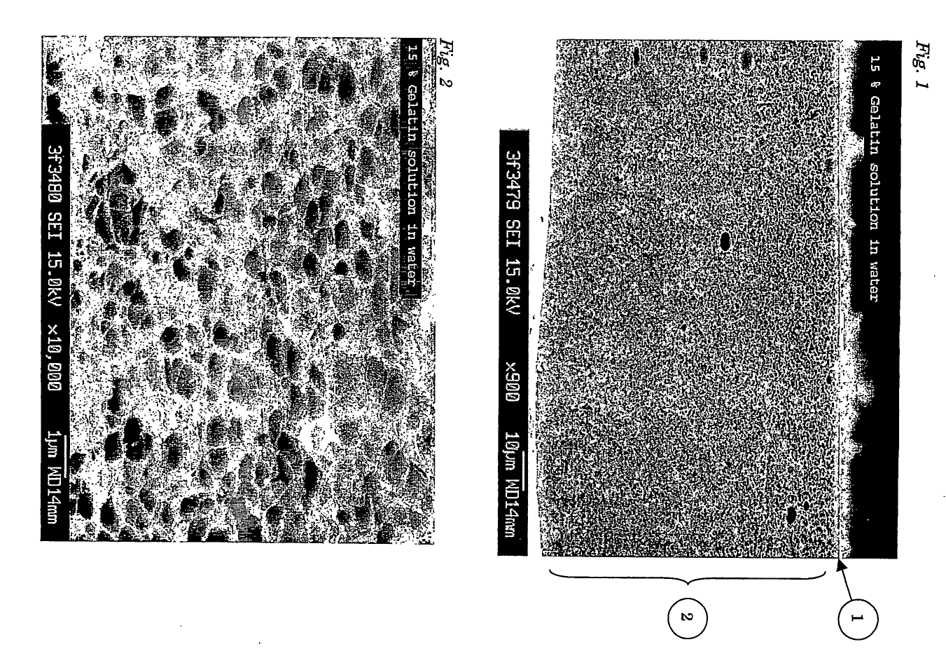

### DETAILED DESCRIPTION

The present invention is directed to providing an ink jet recording medium comprising a support and a microporous layer coated on top of the support. The microporous layer according to this invention comprises at least a water-swellable polymer. This microporous ink jet medium provides advantages with regard to the quality of the printed image thereon. Without wishing to be bound by theory, it is believed that when an image is printed on the inventive microporous-swellable media, the ink solvent is readily absorbed by said media through two mechanisms, i.e. through the ability of the layer to swell and through the capillary forces which results in a dry surface. Due to this quick absorption, the resolution of image will not degrade and smearing or smudging of the image can be prevented. Also coalescence of ink drops which causes the “beading” phenomena can be avoided.

The advantage of the present invention results from the structure of the microporous layer and the polymer material forming the microporous structure. The structure of the microporous layer is preferably produced using the phase inversion technique. The process of phase inversion typically comprises the steps of coating a homogeneous polymer dissolved in a solvent on a support, followed by contacting the solution with a non-solvent, typically by immersing the coated support in a non-solvent bath, whereby a microporous structure is formed, and followed by a drying process. Other methods to cause phase separation are, e.g. controlled evaporation of the solvent in a solvent/non solvent/polymer system, rapid cooling of the polymer solution or by penetration of a non solvent vapour into the polymer solution.

The microporous structure comprises voids which may be isolated from each other by the precipitated and dried water swellable polymer, or which may be partly or totally interconnected.

The degree of swelling is controlled by the chemical composition of the polymer material and/or the chemical or physical cross-linking of the polymer, and as such the ink absorption properties can be carefully controlled by the number and kind of hydrophilic side or functional groups, by the degree of cross-linking or by the combination of these factors. In case of gelatin as a water-swellable polymer the cross-linking can be realized by several chemicals, exploiting the reactivity of the free amine groups of the lysine amino acids or the carboxy groups present in the gelatin. The degree of swelling can be manipulated easily, typically from 3% to 400% or more of the total thickness of the swellable, microporous layer. Preferably the degree of swelling is larger than 7%, more preferably larger than 12%.

On top of the swellable microporous layer a dense polymer layer can be present. This dense polymer layer has certain swelling properties to receive and absorb the ink quickly. This swelling can be limited to 5% or more of its total thickness. The dense toplayer has two functions, viz. to act as an ink receiving layer that absorbs the ink solvent quickly, while keeping the ink dye as much as possible in the toplayer for creating high color densities, and to create the desired gloss level.

In this embodiment of the invention the asymmetric structure, which comprises a thin dense toplayer and a microporous sublayer, can be prepared in one step by the immersion precipitation process itself. Although for convenience the top region is referred to as toplayer and the bottom region as sublayer it is noted that in fact it concerns only one single layer, which is homogeneous in chemical composition, but not homogeneous in structure. Thus in a preferred embodiment, in the medium according to the present invention, the chemical composition of the homogeneous phase of the toplayer is identical or essentially identical to the chemical composition of the homogeneous phase of said sublayer. The choice of a weak non-solvent for the polymer-solvent system results in delayed demixing upon immersion of the polymer-solvent system in the non solvent bath. The out-diffusion of solvent into the non solvent bath is faster than the in-diffusion of non solvent into the polymer solution. This results in the formation of a dense top layer due to demixing at an increased polymer concentration in this layer. After the dense layer is formed, the exchange of solvent and non solvent is hindered by this layer and the exchange rate becomes more equal. This results in the microporous sublayer, due to demixing at lower polymer concentrations compared to the polymer concentration in the top layer. Especially this embodiment, which comprises only a single process step to realize a bi-functional ink absorbing material with a dense top layer and a swellable, microporous sublayer is preferred. Said bi-functional layered structure is highly preferred and is a unique feature of the present invention.

Several ways have been found to create an asymmetric membrane in one single step. The optimal method depends on the selection of the polymers, the solvent and the non-solvent.

As an example, in case gelatin is selected as polymer, it has been found that an asymmetric membrane, comprising a thin dense top layer adjacent to a microporous sub-layer, can be created by selecting water as solvent and ethanol as non-solvent. Admixing this non-solvent into the dope solution increases the thickness of the dense top layer. Addition of another polymer, such as polyvinyl alcohol, polyvinyl pyrollidone, etc. into the gelatin solution also influences the formation of the dense top layer.

In case dimethyl sulfoxide is selected as solvent, another approach needs to be taken for forming an asymmetric membrane e.g. addition of a certain amount of water into the dope solution or increasing the polymer concentration in the dope.

For polyvinylalcohol (PVA) as polymer, it is believed that addition of acetic acid into the dope solution may enhance the formation of the asymmetric membrane. In this case, preferably water is selected as solvent and a basic aqueous solution saturated with sodium sulfate as non-solvent.

Additional to the factors mentioned above, it is also possible to generate an asymmetric membrane by selecting proper process conditions such as the temperature of the non-solvent bath, cooling the coated dope solution for a certain time before immersing it into the coagulation bath, etc.

The methods for making an asymmetric membrane are not limited to the examples mentioned above. By performing further experiments, a person skilled in the art will be able to derive other methods for creating an asymmetric membrane according to the invention.

In another embodiment, the present invention is directed to ink-jet recording media, wherein a top- or skin-layer is present. Apart from applying the toplayer by the above mentioned single-step process, which is preferred, this toplayer may also be applied separately, e.g. in an additional coating step.

It is not always necessary that the dense toplayer is fully closed. Nanopores (viz. having a mean diameter of typically 1 to 100 nm could be present which do not reduce the gloss to a unacceptable degree. Microporosity could increase the ink absorption rate (and therefore the so-called “drying speed”) further. The immersion precipitation method, as described herein tends to result in small pores in the layer contacting the non-solvent, while creating larger pores in the deeper layers, as described earlier.

In one embodiment of the present invention, the microporous coating comprises one or more water-swellable polymers. It is preferred to select said polymer from a group of water soluble polymers.

Unlike the prior art microporous coatings that require the addition of particles to impart porosity, the microporous coating layer of the present invention does not require the addition of particles. Consequently, in a further embodiment of the present invention, the microporous coating layer is essentially free of porosity-imparting particles.

While it is not necessary to incorporate particles into the polymeric coating solution to impart a desired degree of porosity to the microporous coating, it is possible to add particles to the polymeric coating solution to impart a selected physical characteristic to the microporous coating. For example, incorporating pigment particles into the polymeric coating solution can be used to reduce the amount of light transmission through the microporous coating layer, or to give a specific colour to the microporous layer.

Polymeric coating solutions used for fabricating the swellable microporous coating layer preferably contain components selected from the following general categories: polymers, solvents, non-solvents, and additives. The polymers used in this invention are selected from water swellable homopolymers and water swellable copolymers such as, polyvinyl pyrrolidone, hydroxyethyl cellulose, methylcellulose, hydroxypropyl cellulose, hydroxypropylmethyl cellulose, starches, polyethylene oxide, polyvinyl alcohol, polyethylene vinyl alcohol, polyacrylic acids, gelatine, gelatine derivatives, modified gelatins, fully- or partially hydrolysed polyvinyl alcohol, modified polyvinyl alcohol, polyacrylamide, and mixtures thereof.

Gelatine, modified gelatines, polyvinyl alcohol and modified polyvinyl alcohols are preferred. There is a variety of gelatines or modified gelatines, which can be used. For example: alkali-treated gelatine (cattle bone or hide gelatine) or acid-treated gelatine (pigskin gelatine), modified gelatins selected from the group consisting of acetylated gelatin, phthalated gelatin, alkyl quaternary ammonium modified gelatin, succinated gelatin, alkylsuccinated gelatin, gelatin modified with N-hydroxysuccinimide ester of fatty acid and mixture thereof. These gelatines can be used singly or in combination for forming the solvent-absorbing layer used in the image-recording elements of the present invention.

Various kinds of polyvinyl alcohols (PVA) are suitable to be used in this invention. In general a large variety of PVA-based polymers can be used, but the preferred PVA-based polymers are those which have been modified to give a good miscibility with aqueous gelatin solutions. These modifications are such, that in the PVA-based polymer back bone groups are introduced which provide a hydrogen bonding site, an ionic bonding site, carboxylic groups, sulphonyl groups, amide groups and the like, thus providing a modified PVA-based polymer. A modified PVA-based polymer giving very good results is a poly(vinyl alcohol)-co-poly(n-vinyl formamide) copolymer (PVA-NVF). Very suitable PVA-NVF copolymers for use with the present invention are the copolymers described in WO-A-03/054029, which have the general formula I:

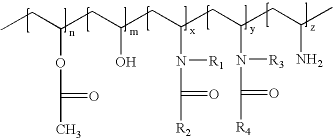

wherein

n is between 0 and about 20 mole percent;

m is between about 50 and about 97 mole percent;

x is between 0 and about 20 mole percent;

y is between 0 and about 20 mole percent;

z is between 0 and about 2 mole percent and

x+y is between about 3 and about 20 mole percent;

R₁, and R₃ are independently H, 3-propionic acid or C₁-C₆ alkyl ester thereof, or is 2-methyl-3-propionic acid or C₁-C₆ alkyl ester thereof; and

R₂ and R₄ are independently H or C₁-C₆ alkyl.

Also low molecular weight PVA can be used.

It is also possible to add a certain amount of non water-swellable polymers, but these should be added in an amount that is preferably lower than 25 wt. % more preferably lower than 20 wt. % in order to maintain a sufficient amount of water swellable polymer.

The concentration of water-swellable polymer in the polymeric coating solution is preferably between about 3 and 50 percent by weight, more preferably between 5 and 40 percent by weight.

In order to obtain a suitable microporous layer for each water-swellable polymer or combination of polymers the optimum combination of solvents and non-solvents can easily be chosen taking into account the following considerations. The solvent is usually selected based on the ability of the solvent to completely dissolve the polymer. It is possible to use a particular solvent by itself or in combination with other solvents.

Suitable solvents for gelatin and its derivatives are water, 2,2,2 trifluoroethanol, acetic acid, ethylene chlorohydrin, dimethylsulfoxide, ethylene glycol, formamide, propionamide, glycerol, and combinations thereof.

Some examples of suitable solvents for PVA are water, mixtures of water and acetic acid, mixtures of water and alcohols, glycols, glycerol, formamide, dimethyl sulfoxide and hexamethylphosphoric triamide.

Preferred non-solvents are those that are capable of causing the polymer in the polymeric dope solution to aggregate. Suitable non-solvents for gelatin and its derivatives are: acetone, methyl acetate, methanol, ethanol, acetonitrile, dimethylcarbonate, nitromethane, dimethylformamide, dimethylacetamide, ethyl-2-pyrrolidone, butyrolactone, triethylphosphate, dimethylsulfone, propylenecarbonate, adiponitrile, and mixtures thereof.

For PVA a suitable non-solvent is a basic aqueous solution comprising Na₂SO₄, ethanol, ketons, carboxyclic acids, esters, hydrocarbons, chlorinated hydrocarbons, tetrahydrofuran (THF).

The phase inversion casting process preferably entails coating a polymeric coating solution onto a support. The coated support is then quenched in a non-solvent bath, to produce a microporous structure. Before this quenching the polymeric coating could be gelled by for instance reducing the temperature to below the gelling temperature.

In another embodiment a coating solution is made in which the water swellable polymer is dissolved in a mixture of solvent and non solvent, in which the non-solvent has a higher boiling point (or lower vapour pressure at a certain temperature) than the solvent. This coating solution is then applied to a support. During drying the phase inversion occurs and a microporous film is formed.

In another embodiment of this invention a multi layer coating is applied on a support. This multi layer coating comprises one layer with at least one water-swellable polymer dissolved in a solvent and another layer comprising a non-solvent, wherein the solvent and the non-solvent mix after coating both layers on the support. The boiling point of the non-solvent should preferably be higher than that of the solvent. During the drying process, that follows the coating process, a microporous layer is formed. Thus the present invention also encompasses embodiments in which a solvent and non-solvent combination is selected, wherein the vapour pressure of the non-solvent at a certain temperature is lower than that of the solvent.

In another embodiment the phase separation is realised by adding a certain amount of electrolytes to the layer comprising the solution of the water swellable polymer. During the drying process the ion concentration will increase resulting in creation of the desired microporous structure caused by the precipitation of the water-swellable polymer.

In another embodiment the polymer precipitation is realised by changing the pH of the coating containing the water swellable polymer. A change of the pH towards the iso-electric point can result in precipitation of the polymer. Such a pH change can be realised by solvent exchange between adjacent layers in a multilayer coating or by passing the coated material through a bath with solvent with a specific pH.

In another embodiment the precipitation might be realised by introducing a temperature shock after coating of the water-swellable polymer solution on a support. Temperature decrease reduces the solubility of the polymer in the solvent and it results in precipitation. This process is know as the so-called Temperature Induced Phase Separation process (TIPS).

In another embodiment a modification of the water-swellable polymer is carried out after coating on the support. This may be done by adding a reagent. The reagent could be added in an adjacent layer or it could be added by leading the material through a bath, which bath contains the reagent e.g. in the form of a solution. The chemical reaction can reduce the hydrophilicity to such an extend that the water-swellable polymer precipitates, for instance by the reduction of the number of charged groups attached to the water-swellable polymer. This process is known as the so-called Reaction Induced Phase Separation process.

An experienced engineer will be able to find similar approaches to realise the precipitation of the water-swellable polymer conform and in line with the principles described herein.

The polymeric coating solution can be coated on a support by any suitable method known in the art. Suitable coating methods are for example, curtain coating, extrusion coating, air-knife coating, slide coating, a roll coating method, reverse roll coating, dip coating processes, spray coating, rod bar coating and the like.

The coated support is generally subsequently dried to remove any solvent and non solvent absorbed during the phase inversion process. A variety of techniques can be used in drying the coated support, such as air knifes, squeegee blades, vacuum rollers, and sponges. Preferably, the drying is performed by a process that does not involve physically touching the coated support to prevent scratching of the coating. This process includes the application of reduced pressure, rapid airflow, radiation by means of infrared, near infrared, microwave and the like, convective heat, or combination thereof.

Depending on the specific selection of components, in particular the solvent, non solvent and the use of optional additives, it was found that the media according to the present invention may have a unique microporous structure, in that the microporous structure may comprise closed pores or cells. Although normally it is preferred to have a pore structure that is open, viz. a pore structure wherein the pores are interconnected to each other by channels, which provides a better ink absorption, it was found that the presence of closed cells in the microporous layer, in particular in the sublayer when a toplayer is present, does not necessarily have an adverse effect on the properties of the media according to the invention. Thus in one embodiment of the present invention at least part of the total void volume is formed by closed cells or pores.

The pores in the microporous sublayer preferably have a void volume of between 5 and 95 volume percent based on the total volume of the ink receptive layer (the volume of the layer corresponds to its surface area multiplied by its mean thickness). The average pore diameter is between 100 nm and 10 μm, preferably between 200 nm and 5 μm.

Preferably the pore structure may be designed such that a thin dense topside of the microporous layer is formed having a void volume of less than 20 volume percent of the ink receptive layer the pores of which have an average pore diameter of less than 1 μm. This more dense topside preferably has a thickness of between 0.1 and 5 μm. In case such a dense topside is formed, a very good gloss is obtained, which may be as high as 60% or even more, when measured using Dr. Lange reflectometer, type Refro-3D under an angle of 60°.

The thickness of the support is believed to be unrelated to the performance of the microporous coating placed on the support. For most printing applications, the support has a thickness of between 5 and 500 micrometers. The thickness of the microporous coating is not necessarily a controlling factor and the optimum thickness of the microporous coating is related to the support on which the microporous coating is formed and the application for which the coated support is to be used. For example, on supports with little or no ink absorptivity, the microporous coating is preferably thicker than in cases where the microporous coating is formed on a highly absorptive support. Additionally, the thickness of the microporous coating may be varied to control the amount of light transmitted to and from the support. For most supports and applications, the microporous coating has a thickness of less than 200 micrometers. Preferably, the dry thickness of the microporous coating is between about 5 and 200 micrometers and more preferably between 10 and 100 micrometers. If the thickness of the microporous layer is less than 5 micrometer, adequate absorption of the solvent will become difficult. The amount of polymer used in the microporous layer is related to the thickness of the microporous layer one wishes to achieve and will generally be between 1 and 100 g/m², preferably between 5 and 50 g/m²

The polymeric coating solution may further comprise various additives, which can be added before applying the solution to the support or after it has been applied. For instance LiCl can be added to influence the pore structure. Also other additives which are commonly applied in traditional membrane technology can be applied.

Cross-linking of the water-swellable polymer provides an excellent means to control the swelling and the mechanical strength. For gelatine, there is a vast number of known cross-linking agents-also known as hardening agents. Examples of the hardener include aldehyde compounds such as formaldehyde and glutaraldehyde, ketone compounds such as diacetyl and chloropentanedion, bis (2-chloroethylurea), 2-hydroxy-4,6-dichloro-1,3,5-triazine, reactive halogen-containing compounds, in particular those disclosed in U.S. Pat. No. 3,288,775, carbamoyl pyridinium compounds in which the pyridine ring carries a sulphate or an alkyl sulphate group, in particular those disclosed in U.S. Pat. No. 4,063,952 and U.S. Pat. No. 5,529,892, divinylsulfones, and the like. These hardeners can be used singly or in combination.

For PVA it is preferable to choose a cross linking agent comprising borax, boric acid, glyoxal or dicarboxylic acids.

The amount of the cross linking agent present in the ink receptive layer preferably ranges from 0.001 g/m² to 10 g/m² and more preferably from 0.001 g/m² to 7 g/m². The cross linking agent may be added in the polymeric solution, in the non-solvent or in both solutions.

The polymeric coating solution may further contain surfactants. These may be anionic surfactants, amphoteric surfactants, cationic surfactants, and non-ionic surfactants.

Examples of anionic surfactants include alkylsulfocarboxylates, alpha-olefin sulfonates, polyoxyethylene alkyl ether acetates, N-acylaminoacids and salts thereof, N-acylmethyltaurine salts, alkylsulphates, polyoxyallylether sulphates, polyoxyalkylether phosphates, rosin soap, castor oil sulphate, lauryl alcohol sulphate, alkyl phenol phosphates, alkyl phosphates, alkyl allyl sulfonates, diethylsulfosuccinates, diethylhexylsulfosuccinates, dioctylsulfosuccinates, and the like.

Examples of the cationic surfactants include 2-vinylpyridine derivatives and poly-4-vinylpyridine derivatives.

Examples of the amphoteric surfactants include lauryl dimethyl aminoacetic acid betaine, 2-alkyl-N-carboxymethyl-N-hydroxyethyl imidazolinium betaine, propyldimethylaminoacetic acid betaine, polyoctyl polyaminoethyl glycine, and imidazoline derivates.

Useful examples of non-ionic surfactants include non-ionic fluorinated surfactants and non-ionic hydrocarbon surfactants. Useful examples of non-ionic hydrocarbon surfactants include ethers, such as polyoxyethylene nonyl phenyl ether, polyoxyethylene octyl phenyl ether, polyoxyethylene dodecyl phenyl ether, polyoxyethylene alkyl allyl ethers, polyoxyethylene oleyl ethers, polyoxyethylene lauryl ethers, polyoxyethylene alkyl ethers, polyoxyalkylene alkyl ethers; esters, such as polyoxyethylene oleate, polyoxyethylene distearate, sorbitan laurate, sorbitan monostearate, sorbitan monooleate, sorbitan sesquioleate, polyoxyethylene monooleate, polyoxyethylene stearate; glycol surfactants and the like. The above-mentioned surfactants are preferably present in the polymeric coating solution in an amount ranging from 0.1 to 1000 mg/m², preferably from 0.5 to 100 mg/m².

The polymeric coating solution may further comprise one or more of the following ingredients:

Matting agents such as titanium dioxide, zinc oxide, silica and polymeric beads such as cross linked poly(methyl methacrylate) or polystyrene beads for the purposes of contributing to the non-blocking characteristics of the recording elements used in the present invention and to control the smudge resistance thereof. These matting agents may be used alone or in combination

One or more plasticizers, such as ethylene glycol, diethylene glycol, propylene glycol, polyethylene glycol, glycerol monomethylether, glycerol monochlorohydrin, ethylene carbonate, propylene carbonate, tetrachlorophthalic anhydride, tetrabromophthalic anhydride, urea phosphate, triphenylphosphate, glycerolmonostearate, propylene glycol monostearate, tetramethylene sulfone, N-methyl-2-pyrrolidone, N-vinyl-2-pyrrolidone, and polymer lattices with low Tg-value such as polyethylacrylate, polymethylacrylate, etc.

One or more fillers. As mentioned above, the presence of porosity-imparting particles is not essential. Nevertheless, some of the conventional fillers may be used, some of which fillers may impart further porosity. Both organic and inorganic particles can be used as fillers. Useful fillers are for example, silica (colloidal silica), alumina or alumina hydrate (aluminazol, colloidal alumina, a cation aluminum oxide or its hydrate and pseudo-boehmite), a surface-processed cat ion colloidal silica, aluminum silicate, magnesium silicate, magnesium carbonate, titanium dioxide, zinc oxide, calcium carbonate, kaolin, talc, clay, zinc carbonate, satin white, diatomaceous earth, synthetic amorphous silica, aluminum hydroxide, lithopone, zeolite, magnesium hydroxide and synthetic mica. Among these inorganic fillers, porous inorganic fillers are preferable such as porous synthetic silica, porous calcium carbonate and porous alumina. Useful examples of organic fillers are represented by polystyrene, polymethacrylate, polymethyl-methacrylate, elastomers, ethylene-vinyl acetate copolymers, polyesters, polyester-copolymers, polyacrylates, polyvinylethers, polyamides, polyolefines, polysilicones, guanamine resins, polytetrafluoroethylene, elastomeric styrene-butadiene rubber (SBR), urea resins, urea-formalin resins. Such organic and inorganic fillers may by used alone or in combination.

One or more mordants. Mordants may be incorporated in the ink-receptive layer of the present invention. Such mordants are represented by cationic compounds, monomeric or polymeric, capable of complexing with the dyes used in the ink compositions. Useful examples of such mordants include quaternary ammonium block copolymers. Other suitable mordants comprise diamino alkanes, ammonium quaternary salts and quaternary acrylic copolymer latexes. Other suitable mordants are fluoro compounds, such as tetra ammonium fluoride hydrate, 2,2,2-trifluoroethylamine hydrochloride, 1-(alpha, alpha, alpha-trifluoro-m-tolyl) piperazine hydrochloride, 4-bromo-alpha, alpha, alpha-trifluoro-o-toluidine hydrochloride, difluorophenylhydrazine hydrochloride, 4-fluorobenzylamine hydrochloride, 4-fluoro-alpha, alpha-dimethylphenethylamine hydrochloride, 2-fluoroethylaminehydrochloride, 2-fluoro-1-methylpyridinium-toluene sulfonate, 4-fluorophenethylamine hydrochloride, fluorophenylihydazine hydrochloride, 1-(2-fluorophenyl) piperazine monohydrochloride, 1-fluoro pyridinium trifluoromethane sulfonate.

One ore more conventional additives, such as:
Pigments: white pigments such as titanium oxide, zinc oxide, talc, calcium carbonate and the like; blue pigments or dyes such as cobalt blue, ultramarine or phthalocyanine blue; magenta pigments or dyes such as cobalt violet, fast violet or manganese violet;
Biocides;
pH controllers;
Preservatives;
Viscosity modifiers;
Dispersing agents;
UV absorbing agents;
Brightening agents;
Anti-oxidants; and/or
Antistatic agents.

These additives may be selected from known compounds and materials in accordance with the objects to be achieved.

The above-mentioned additives (matting agents, plasticizers, fillers/pigments, mordants, conventional additives) may be added in a range of 0 to 30% by weight, based on the solid content of the water swellable microporous ink receiving layer composition.

The particle sizes of the non water-soluble particulate additives should not be too high, since otherwise a negative influence on the resulting pore structure will be obtained. The used particle size should therefore preferably be less than 10 μm, more preferably 7 μm or less. The particle size is preferably above 0.1 μm, more preferably about 1 μm or more for handling purposes.

The microporous coatings may be formed on a variety of supports. The selection of a support is primarily based on the application in which the coated medium is to be used. The support used in this invention may suitably be selected from a paper, a pigment coated paper, a laminated paper, a laminated pigment coated paper, a photographic base paper, a synthetic paper or a plastic film in which the top and back coatings are balanced in order to minimise the curl behavior.

It has been found that the gloss of the medium can be improved by selecting the appropriate surface roughness of the used support. It was found, that providing a support having a surface roughness characterised by the value Ra being less than 1.0 μm, preferably below 0.8 μm a very glossy medium can be obtained. A low value of the Ra indicates a smooth surface. The Ra is measured according to DIN 4776; software package version 1.62 with the following settings:

(1) Point density 500 P/mm (2) Area 5.6×4.0 mm² (3) Cut-off wavelength 0.80 mm (4) Speed 0.5 mm/sec., using a UBM equipment.

The base paper to be used as the support for the present invention is selected from materials conventionally used in high quality printing paper. Generally it is based on natural wood pulp and if desired, a filler such as talc, calcium carbonate, TiO₂, BaSO₄, and the like can be added. Generally the paper also contains internal sizing agents, such as alkyl ketene dimer, higher fatty acids, paraffin wax, alkenylsuccinic acid, epichlorhydrin fatty acid amid and the like. Further the paper may contain wet and dry strength agents such as a polyamine, a poly-amide, polyacrylamide, poly-epichlorhydrin or starch and the like. Further additives in the paper can be fixing agents, such as aluminium sulphate, starch, cationic polymers and the like. The Ra value for a normal grade base paper is well above 1.0 μm typically above 1.3 μm. In order to obtain a base paper with a Ra value below 1.0 μm such a normal grade base paper can be coated with a pigment. Any pigment can be used. Examples of pigments are calcium-carbonate, TiO₂, BaSO₄, clay, such as kaolin, styrene-acrylic copolymer, Mg—Al-silicate, and the like or combinations thereof. The amount being between 0.5 and 35.0 g/m² more preferably between 0.5 and 20.0 g/m². This pigmented coating can be applied as a pigment slurry in water together with a suitable binders like styrene-butadiene latex, methyl methacrylate-butadiene latex, polyvinyl alcohol, modified starch, polyacrylate latex or combinations thereof, by any technique known in the art, like dip coating, roll coating, blade coating or bar coating. The pigment coated base paper may optionally be calendered. The surface roughness can be influenced by the kind of pigment used and by a combination of pigment and calendering. The base pigment coated paper substrate has preferably a surface roughness between 0.4 and 0.8 μm. If the surface roughness is further reduced by super calendering to values below 0.4 μm the thickness and stiffness values will generally become below an acceptable level.

The ink receiving multilayer of the present invention can be directly applied to the pigment coated base paper. In another embodiment, the pigment coated base paper having a pigmented top side and a back-side is provided on both sides with a polymer resin through high temperature co-extrusion giving a laminated pigment coated base paper. Typically temperatures in this (co-)extrusion are above 280° C. but below 350° C. The preferred polymers used are poly olefins, particularly polyethylene. In a preferred embodiment the polymer resin of the top side comprises an opacifying white pigment e.g. TiO₂ (anatase or rutile), ZnO or ZnS, dyes, coloured pigments, including blueing agents e.g. ultramarine or cobalt blue, adhesion promoters, optical brighteners, antioxidant and the like to improve the whiteness of the laminated pigment coated base paper. By using other than white pigments a variety of colors of the laminated pigment coated base paper can be obtained. The total weight of the laminated pigment coated base paper is preferably between 80 and 350 g/m². The laminated pigment coated base paper shows a very good smoothness, which after applying the ink receiving layer of the present invention results in a recording medium with excellent gloss.

Other supports used in this invention may suitably be selected from a synthetic paper or a plastic film in which the top and back coatings are balanced in order to minimise the curl behaviour.

Examples of the material of the plastic film are polyolefins such as polyethylene and polypropylene, vinyl copolymers such as polyvinyl acetate, polyvinyl chloride and polystyrene, polyamide such as 6,6-nylon and 6-nylon, polyesters such as polyethylene terephthalate, polyethylene-2 and 6-naphthalate and polycarbonate, and cellulose acetates such as cellulose triacetate and cellulose diacetate. The support may have a gelatin subbing layer to improve coatability of the support. The support may be subjected to a corona treatment in order to improve the adhesion between the support and the ink receiving layer. Also other techniques, like plasma treatment can be used to improve the adhesion.

If desired, after the microporous layer of this invention is formed it may be overcoated with an ink-permeable, anti-tack protective layer, such as, for example, a layer comprising a cellulose derivative such as hydroxymethyl cellulose, hydroxyethyl cellulose, hydroxypropyl methyl cellulose and carboxymethyl cellulose. The topcoat layer is non-porous, but is ink-permeable and serves to improve the optical density of the images printed on the element with water-based inks. The topcoat layer also serves to protect the microporous layer from abrasion, smudging and water damage.

The topcoat material preferably is coated onto the microporous layer from water or water-alcohol solutions at a dry thickness ranging from 0.1 to 8.0 micrometers, more preferably 0.5 to 4.0 micrometers. The topcoat layer may be coated in a separate operation step after the microporous layer is obtained by the phase inversion technique.

In practice, various additives may be employed in the topcoat. These additives include surface active agents which control the wetting or spreading action of the coating mixture, anti-static agents, suspending agents, particulates which control the Fictional properties or act as spacers for the coated product, antioxidants, UV-stabilizers and the like.

The present invention will be illustrated in detail by the following non-limiting examples.

### EXAMPLES

Determination of Membrane Structure

In order to analyze the membrane structure, cross section pictures were made using a Field Emission Scanning Electron Microscope (JEOL USA, model JSM-6330F). The thickness of the dense toplayer was determined from the cross section pictures.

Drying Test

A standard black image (4 cm×4 cm) was printed on the ink jet media by using a HP995c printer containing the original HP inks. The following printer setting was selected:

Print quality: Best

Paper Type: hp premium plus photo paper, glossy

Paper size: A4

The drying property of the ink jet media was evaluated by wiping the four corners of the printed image gently with a finger directly after the paper was fed out of the printer. The drying speed of the ink-jet media was determined by analyzing visually the density of the smeared inks. The following categories were adapted:

◯: no ink smearing at all

X: ink smearing is visible from 2 or more corners.

Absorption Speed Measurement

The absorption speed of a water drop having a volume of 20 nano L was measured by using a contact angle apparatus (VCA2500XE made by AST Inc. USA). Directly after putting the water-drop onto the medium, the drop was recorded, the contact angle between the drop and the medium was measured and the volume of the drop was calculated by the standard software belonging to the apparatus. The measurement and calculation was repeated at certain time intervals depending on the speed of absorption.

In this measurement we defined the “time-zero” as the time that the first drop volume is measured. The absorption speed is calculated by the following formula:
Absorption speed=|dV/dt|
wherein dV is the volume decrease within a small time difference dt. The absorption speed is calculated within a maximum time of 5 seconds.

Gloss Measurement

The glossiness of the ink jet medium was measured by using the reflectometer Dr. Lange, type Refro-3D under an angle of 60°.

Ozone Fastness Test.

A standard color pattern comprising cyan, magenta and yellow having different densities, was printed on the ink jet media by using a HP 5652 printer containing ink cartridge nr. 57 and 58. After printing said pattern, the printed medium was stored in an ozone chamber OTC-1 (In USA Inc., USA), for 48 hours at room temperature. The ozone concentration in said chamber was 5 ppm. The color densities of the printed pattern was measured by an auto scan spectrophotometer (X-rite Inc. USA, model DTP41B) before and after the ozone treatment. The ozone fastness properties of the ink jet media were determined by calculating the decrease of the color density which has a beginning density of 1±0.05. This method is suggested by the Wilhelm Imaging Research company in USA.

### Inventive Example 1

A homogeneous dope solution was prepared by adding 20 g of lime-processed gelatin, having an average MW of 193 kD, into 80 g dimethylsulfoxide (from Merck, Germany) under agitation at 45° C. for 2.5 hours.

Method for Making a Porous Ink Jet Medium

A photographic grade paper (205 g/m²) laminated with polyethylene at both sides was used as a support. The surface was corona treated to enhance the wettability prior to coating the solution by means of a knife coater with an opening of 100 μm. The coated support was immediately immersed into a 20° C. ethanol bath (absolute grade from Merck, Germany) and kept for 30 minutes, upon which a porous layer was formed on the support. The porous layer was then dried for ca. 14 hours (overnight) under vacuum.

The resulting porous ink jet medium was subjected to the drying test and the result is summarized in Table 1.

### Inventive Example 2

A gelatin dope solution was prepared by mixing 20 g of lime processed gelatin (MW average=193 kD) with 50 g of water at room temperature, and leaving it for 90 minutes to allow the gelatin to swell, then rising the temperature up to 60° C. to make it completely soluble under stirring. After the gelatin solution was completely dissolved, the temperature was reduced to 40° C. and 30 g of ethanol was added into the solution under rigorous agitation and kept for 30 minutes to allow the dope solution to form a homogenous mixture. Herein was added 3 g of a cross-linking solution containing 7.5 wt % of 2-hydroxy-4,6-dichloro-1,3,5-triazine. A porous ink jet medium was then prepared by using this solution according to the method mentioned in example 1. In stead of a knife coater, a KH coater bar 200 (wet thickness of 200 micro meter) was used for coating the solution onto the photographic grade paper. After drying, the membrane was further conditioned at 20° C. and 65% RH for at least 24 hours to allow the hardener to crosslink the gelatin sufficiently.

The resulting porous ink jet medium was subjected to the drying test and the result is summarized in Table 1.

### Inventive Example 3

A homogeneous dope solution was prepared by adding 15 g of deionised lime-processed gelatin having average MW of 193 kD into 84 g water under agitation at room temperature, and leaving it for 90 minutes to allow gelatin to swell. Thereafter, the dope solution was dissolved at a temperature of 60° C. When the gelatin was completely dissolved, the temperature was reduced to 40° C. One gram of ethanol (absolute grade from Merck, German) was added into the solution under rigorous agitation and kept for 30 minutes to allow the solution to form a homogenous mixture. A porous ink jet medium was then prepared by coating said solution onto a laminated photo-grade-paper and immersing it into an ethanol bath according to the procedure mentioned in example 1. In stead of a knife coater, a KH coater bar 200 was used. The temperature of the immersion bath was set to 25° C. The film was dried for 30 minutes under vacuum.

The resulting porous ink jet medium was subjected to the drying test, gloss and absorption speed measurement, and ozone fastness evaluation. The results are summarized in Table 1, 2 and 3.

### Inventive Example 4

A homogeneous dope solution containing 15 wt % gelatin was made according to the method mentioned in example 3, wherein the amount of ethanol in the gelatin solution was increased to 5 wt %. A porous ink jet medium was then prepared by coating said solution onto a laminated photo-grade-paper and immersing it into an ethanol bath according to the procedure mentioned in example 3.

The resulting porous ink jet medium was subjected to the drying test, gloss and absorption speed measurement. The results are summarized in Table 1 and 2.

### Inventive Example 5

A homogeneous dope solution containing 15 wt % gelatin was made according to the method mentioned in example 3, wherein the amount of ethanol in the gelatin solution was increased to 15 wt %. A porous ink jet medium was then prepared by coating said solution onto a laminated photo-grade-paper and immersing it into an ethanol bath according to the procedure mentioned in example 3.

The resulting porous ink jet medium was subjected to the drying test, gloss and absorption speed measurement, and ozone fastness evaluation. The results are summarized in Table 1, 2 and 3.

### Inventive Example 6

A mixture of a modified polyvinyl alcohol and gelatin solution containing 2.5 wt % of PVA was prepared as follows:

10 wt % poly(vinyl alcohol)-co-poly(n-vinyl formamide) copolymer (PVA-NVF), purchased from Ciba Specialty Chemicals, Germany, was dissolved in water at 85° C.

10 grams of said 10 wt % PVA-NVF solution was added into a 30 gram lime-processed gelatin solution having a gelatin concentration of 15 wt % at a temperature of 40° C. (average MW of the gelatin was 200 kD). A porous ink jet medium was then prepared by coating said solution onto a laminated photo-grade-paper and immersing it into an ethanol bath according to the procedure mentioned in Example 3.

The resulting porous ink jet medium was subjected to the drying test, gloss and absorption speed measurement, and ozone fastness evaluation. The results are summarized in Table 1, 2 and 3.

### Inventive Example 7

A dope solution containing 15 wt % gelatin was made according to the method mentioned in example 3, wherein no ethanol was added into the gelatin solution. A porous ink jet media was then prepared by coating said solution onto a laminated-photo-grade-paper and immersing it into an ethanol bath according to the procedure mentioned in example 3.

The resulting porous ink jet media was subjected to the drying test, gloss and absorption speed measurement, and ozone fastness evaluation. The results are summarized in Table 1, 2 and 3.

### Comparative Example 1

Ink jet paper having a photo grade quality and known as typical swellable paper was purchased. from the market. Some examples of the swellable type include HP Premium Plus photo paper—Glossy, FujiFilm Premium Plus Photo Paper and Ilford Classic Gloss Paper. One of these papers was subjected to the drying test, gloss and absorption speed measurement and ozone fastness evaluation. The results are mentioned in Table 1,2 and 3.

### Comparative Example 2

The same evaluation was done to one of the available ink jet papers of photo grade quality and known as typical microporous ink jet media. Some examples of the microporous type are Epson Premium Glossy Photo Paper, Fuji Film Premium Photo Paper and Canon Photo Paper Pro.

TABLE 1
Drying speed

| Nr. | Dope solution | Drying test |
|---|---|---|
| Ex. 1 | 20% Gel. in DMSO | ◯ |
| Ex. 2 | 20% Gel. + 30% EtOH + | ◯ |
| | Cross linker | |
| Ex. 3 | 15% Gel + 1% EtOH | ◯ |
| Ex. 4 | 15% Gel + 5% EtOH | ◯ |
| Ex. 5 | 15% Gel + 15% EtOH | ◯ |
| Ex. 6 | 2.5% PVA + 11.25% Gel. | ◯ |
| Ex. 7 | 15% Gel. | ◯ |
| Comp. 1 (swellable) | — | X |
| Comp. 2 (microporous) | — | ◯ |

Table 1 shows qualitative data of the drying speed of a printed image on the ink jet media. As can be seen, the ink jet media according to the present invention improve significantly the drying speed of the black colored image, which is a combination of a cyan, magenta and yellow ink (high ink load).

TABLE 2
Absorption speed and gloss

| | | | Gloss | Absorption |
|---|---|---|---|---|
| | | | value | speed |
| | | Thickness of | at | [nanoliter |
| | | dense layer | 60° | per |
| Nr | Dope solution | [μm] | [%] | sec] |
| Ex. 3 | 15% Gel + 1% EtOH | 2 | 85 | 1.3 |
| Ex. 4 | 15% Gel + 5% EtOH | 3 | 90 | 0.8 |
| Ex. 5 | 15% Gel + 15% | 7 | 95 | 0.5 |
| | EtOH | | | |
| Ex. 6 | 2.5% PVA + 11.25% | 2.6 | 30 | 2.0 |
| | Gel. | | | |
| Ex. 7 | 15% Gel. | 1 | 81 | 1.4 |
| Comp. 1 | | — | 87 | 0.3 |
| Swellable | | | | |
| Comp. 2 | | — | 55 | 4 |
| Microporous | | | | |

Table 2 shows the quantitative data of the absorption speed of a water drop. It can be seen that the absorption speed of the ink jet media according to this invention is significantly better than that of the swellable type available in the market. It can be concluded that a mixture of PVA and Gelatin improves the absorption speed even further, approaching the microporous type.

Table 1 and 2 teaches us that the improvements on the absorption speed of the present invention in fact satisfies the need to dry a printed image almost instantaneously.

Table 2 teaches us further that the glossiness of the ink jet media according to the present invention may be varied by the composition of the dope solution. The thicker the dense top layer, the higher the glossiness of the medium will be and the lower the absorption speed. It can be appreciated by persons skilled in the art that depending on the application an optimum balance between the desired glossiness and absorption speed can be found by this invention.

TABLE 3
Ozone fastness

| | | Ozone fastness | | |
|---|---|---|---|---|
| | | Density decrease | | |
| | | after ozone | | |
| | | treatment [%] | | |
| Nr. | Dope solution | Cyan | Magenta | Yellow |
| Ex. 3 | 15% Gel. + 1% EtOH | <1 | 8 | 5 |
| Ex. 5 | 15% Gel. + 15% EtOH | 5 | 10 | 8 |
| Ex. 6 | 2.5% PVA + 11.25% Gel. | 8 | 18 | 10 |
| Ex. 7 | 15% Gel. | <1 | 7 | 5 |
| Comp. 1 | | 17 | 22 | 5 |
| (Swellable) | | | | |
| Comp. 2 | | 58 | 88 | 50 |
| (microporous) | | | | |

Table 3 shows us that the ozone fastness of the ink jet media according to this invention is much better compared to that of the comparative example 2 (microporous type) and even somewhat better than of the comparative example 1 (swellable type).

From Table 1, 2 and 3 it can be concluded that the present invention has successfully adapted the best properties of the two existing types of ink jet media in one medium. The ink jet media according to the present invention have thus improved the absorption speed compared to the swellable type significantly and at the same time improved drastically the ozone fastness properties compared to the microporous type.

1. An ink-jet recording medium comprising a support and a water-swellable ink-receiving layer adhered to said support, wherein said ink-receiving layer has an asymmetric membrane structure comprising a dense top layer adjacent to a microporous sublayer, wherein the chemical composition of the homogeneous phase of said top layer is essentially identical to the chemical composition of the homogeneous phase of said sublayer, which ink-receiving layer comprises at least one water-swellable polymer.

2. The medium according to claim 1, wherein said water-swellable polymer forms at least 75% of the dry weight of said top layer and of said sublayer.

3. The medium according to claim 1, wherein the microporous layer is substantially free of porous pigment particles.

4. The medium according to claim 1, wherein said microporous sublayer comprises 5 to 95 vol. % voids, based on the total volume of the ink-receiving layer.

5. The medium according to claim 1, wherein the average diameter of the pores of said microporous sublayer is between 100 nm and 10 μm.

6. The medium according to claim 1, wherein the swell in a hydrophilic medium of said ink-receiving layer is more than 3% of the total thickness of the dry layer.

7. The medium according to claim 1, wherein said top layer comprises less than 20% voids on the total volume of the ink-receiving layer and the average pore size is less than 1 μm.

8. The medium according to claim 1, wherein the thickness of said top layer is less than 5 μm.

9. The medium according to claim 1, wherein said water-swellable polymer is selected from the group consisting of polyvinyl pyrrolidone, hydroxyethyl cellulose, methylcellulose, hydroxypropyl cellulose, hydroxypropylmethyl cellulose, starches, polyethylene oxide, polyvinyl alcohol, polyacrylic acids, polyethylene alcohol, gelatine, gelatine derivatives, modified gelatins, fully or partially hydrolysed polyvinyl alcohol, modified polyvinyl alcohol, polyacrylamide, and mixtures thereof.

10. The medium according to claim 9 wherein said water-swellable polymer is selected from the group consisting of gelatin, modified gelatin, hydrolyzed gelatin, PVA, modified PVA, copolymers or terpolymers based on PVA and mixtures thereof.

11. The medium according to claim 1, wherein said ink-receiving layer further comprises a cross linking agent in the amount of 0.001 to 10 g/m².

12. The medium according to claim 1, wherein said support is a paper, a pigment coated paper, a laminated paper, a laminated pigment coated paper, a photographic base paper, a synthetic paper or a plastic film.

13. A process for producing a microporous ink-jet recording medium, comprising the successive steps of:
selecting an appropriate combination of components comprising a water-swellable polymer, a solvent and a non-solvent fluid;
preparation of a homogeneous formulation comprising said water-swellable polymer in said solvent;
coating said formulation on a support;
contacting the coated support with said non-solvent fluid, which causes said water-swellable polymer to precipitate and form an asymmetric microporous membrane comprising a dense top layer adjacent to a microporous sublayer; and
drying said coated support.

14. A process for producing a microporous ink-jet recording medium, comprising the successive steps of:
selecting an appropriate mixture comprising a water-swellable polymer, a solvent and a non-solvent;
preparation of a formulation comprising a mixture of said water-swellable polymer, said solvent and said non-solvent in a ratio that a homogenous polymer solution is obtained, wherein the boiling point of the non-solvent is higher than the boiling point of the solvent;
coating said formulation on a support and drying said coated support at the condition wherein the solvent is first evaporated followed by the non-solvent which causes said water-swellable polymer to precipitate and form an asymmetric microporous membrane comprising a dense top layer adjacent to a microporous sublayer.

15. A method of forming a permanent, precise ink-jet image comprising the steps of:
providing an ink-jet recording medium as is described in claim 1; and
introducing ink-jet ink into contact with the medium in the pattern of a desired image.

16. The medium according to claim 1, wherein the swell in a hydrophilic medium of said ink-receiving layer is more than 7% of the total thickness of the dry layer.

17. The medium according to claim 1, wherein the swell in a hydrophilic medium of said ink-receiving layer is more than 12% of the total thickness of the dry layer.

18. The medium according to claim 1, wherein said top layer comprises less than 20% voids on the total volume of the ink-receiving layer and the average pore size is between 1 and 100 nm.

19. The medium according to claim 1, wherein the thickness of said top layer is between 0.1 to 5.0 μm.

20. The medium according to claim 1, wherein said ink-receiving layer further comprises a cross linking agent in the amount of from 0.001 to 7 g/m².

21. A method of forming a permanent, precise ink-jet image comprising the steps of:
providing an ink-jet recording medium made by the process according to claim 13; and
introducing ink-jet ink into contact with the medium in the pattern of a desired image.
